(19) United States
(12) Patent Application Publication
(10) Pub. No.: US 2025/0054287 A1
(43) Pub. Date: Feb. 13, 2025

(54) Multi-Source Object Detection and Identification

(71) Applicant: Vivint, Inc., Provo, UT (US)

(72) Inventors: Erik Stephen Pfeiffer, Provo, UT (US); RONGBIN Lanny Lin, Provo, UT (US); Michelle Bea Zundel, Provo, UT (US)

(73) Assignee: Vivint, Inc., Provo, UT (US)

(21) Appl. No.: 18/796,969

(22) Filed: Aug. 7, 2024

Related U.S. Application Data
(60) Provisional application No. 63/518,485, filed on Aug. 9, 2023.

(51) Int. Cl. G06V 10/80; G06V 10/75; G06V 10/764; G06V 10/776; G06V 20/52; G06V 40/10; G06V 40/20

(52) U.S. Cl. CPC G06V 10/811; G06V 10/751; G06V 10/764; G06V 10/776; G06V 20/52; G06V 40/20; G06V 40/10

(57) ABSTRACT

A computer-implemented method may include receiving first data from a first sensor. The first data may include data associated with a potential object within an evaluation field of the first sensor. The method may include receiving second data from a second sensor. The second data may include data associated with a potential object within an evaluation field of the second sensor. The first and second sensors may be different. The method may include determining a first identity classification of the potential object within the evaluation field of the first sensor. The method may include determining a second identity classification of the potential object within the evaluation field of the second sensor. The method may include determining a final identity of the potential object of the first sensor or the second sensor. The method may include performing a security action based on the final identity of the potential object.

### CROSS REFERENCE TO RELATED APPLICATION

This application is a claims priority to U.S. Patent Application Ser. No. 63/518,485, filed Aug. 9,2023, the entire contents of which are hereby incorporated by reference as though fully set forth herein.

### BACKGROUND

The present disclosure relates to automation systems that include a multi-source object identification method. Automation systems are widely deployed in a smart environments (e.g., a residential, a commercial, or an industrial setting). Automation systems often include security subsystems that are designed to secure the environment through one or more appropriate response actions, which are based on a recognition and identification of detected objects. Correctly detecting objects, their identities, and whether they present threats are, individually and collectively, critical to identifying an appropriate responsive action in a security subsystem. However, as demand for automation systems that provide security capabilities increases, some automation systems fail to provide accurate and reliable detection of potential objects, classification the potential object that is detected, recognition of threats, which often causes implemented response actions to be ineffective.

The subject matter claimed herein is not limited to embodiments that solve any disadvantages or that operate only in environments such as those described above. Rather, this background is only provided to illustrate one example technology area where some embodiments described herein may be practiced.

### BRIEF DESCRIPTION OF THE DRAWINGS

Embodiments will be described and explained with additional specificity and detail through the use of the accompanying drawings, in which:

FIG. 1 illustrates an example of a security and automation system in accordance with aspects of the present disclosure;

FIG. 2 illustrates components of a security subsystem of a security and automation system;

FIGS. 3A-3B illustrate a flow diagram of a process for providing security to an

environment; and

FIG. 4 illustrates a flowchart of an example method for providing security to an environment.

### DETAILED DESCRIPTION

Automation systems that provide security capabilities in homes and businesses have become commonplace as people seek to guard themselves and their property. These security and automation systems may employ sensors at entry and exit points, along with interior sensors (e.g., motion detectors, sound sensors, and glass break sensors) for determining entry or exit into or out of a property. In addition, these security and automation systems may employ security cameras that perform various operations related to crime or other circumstances. Embodiments described herein relate to a security subsystem within an automation system (referred to in the present disclosure as “security and automation systems”) that is capable of detecting and identifying potential objects, determining whether the detected objects present a threat, and performing a security action based on the detection of, identity of, and/or threat level presented by detected objects.

In one embodiment, security and automation systems for protecting an environment and related methods are provided. An environment, according to the present disclosure, may include an area in and around a structure. For example, an environment may include a residential structure such as a home, or a commercial structure, such as a warehouse, garage, store, gym, etc.

In one embodiment, one or more sensors may gather data from one or more evaluation fields. An evaluation field, according to the present disclosure, may include an area from which a sensor may be capable of gathering data. Any number of different types of sensors may be included in the security and automation systems of the present disclosure. For example, a sensor may include an image sensor, such as a camera, and the data gathered may include one or more images. In this embodiment, the evaluation field may be the boundaries, or edges, of the images captured by the image sensor.

In another embodiment, a sensor may include a depth sensor, such as a radio detection and ranging (RADAR) device, a time of flight (ToF) device, or a light detection and ranging (LiDAR) device. In this embodiment, the data gathered may include movement of a potential object, a distance between the potential object and the sensor, a vibration of the potential object, a speed of the potential object, a size of the potential object, an interaction between two objects, such as a person touching a car or a mailbox or a parcel, leaving a car door open, or leaving a car running. The evaluation field in this embodiment may include the boundaries within which the sensor is capable of detecting movement, distance, vibration, speed, or size.

In some embodiments, a depth sensor may comprise a radio-frequency sensor. A radio-frequency sensor may utilize Wi-Fi, Bluetooth®, ultra-wideband (UWB), and/or other radio-frequency signals (e.g., which the radio-frequency sensor may transmit and/or receive, which may already be present in, near, and/or around a building) to detect and/or track locations and/or movement of people, animals, devices, objects, or the like. For example, a radio-frequency sensor may detect and/or locate transmitting radio frequency devices, such as mobile telephones, tracking tags, or the like and determine locations and/or movement based on a received and/or detected signal strength, triangulation, device fingerprinting, time-of-flight, angle of arrival, or the like.

In another embodiment, a sensor may include an audio sensor, such as a microphone, and the data gathered may include one or more sounds. In this embodiment, the evaluation field may include the boundaries within which the sensor is capable of detecting sound.

In some embodiments, data gathered by one or more of the sensors may be limited to a region of interest (ROI). This ROI may be a part or portion of an evaluation field of the sensor. For example, a video camera sensor whose evaluation field includes all of the property in front of a home may have an ROI that is limited to a driveway of the home.

In some embodiments, the security and automation system may receive data from one or more sensors and use this data to determine an identity classification for a potential object. An identity classification for a potential object may include a human, an animal, a nonliving object, or an absence of an object from the sensor's evaluation field. In addition to these broad classifications, the identity classification may also include one or more subcategories to which the potential object belongs. For example, the security and automation system may classify a potential object as a human, and also determine that the human is female and a child. In another example, the security and automation system may classify a potential object as an animal, and also determine that the animal is a cat. In another example, the security and automation system may classify a potential object as a nonliving object, and also determine that the object is a box or other parcel.

In addition to an identity classification, the security and automation system may also determine an identity likelihood score. An identity likelihood score may provide a confidence level that the identity classification is accurate. The identity likelihood score may be presented in the form of a number, such as a percentage, or another representation of a confidence level. For example, based on data gathered by a sensor, a potential object may be classified as a human with an identity likelihood score of 70%. In this example, the system would be 70% confident that the sensed object is a human. In some embodiments, identity likelihood scores may be weighted based on an accuracy rating of the sensor from which the data is received.

In some embodiments, two or more different types of sensors may be present in a security and automation system. Data may be received from each of these sensors and the security and automation system may determine an identity classification separately for each. The security and automation system may also determine identity likelihood scores separately from the data received from each of the different types of sensors.

Once the security and automation system has determined one or more identity classifications (and in some embodiments, the one or more identity likelihood scores) for a potential object, the security and automation system may determine a final identity of the potential object. This determination may be based on one or more identity classifications alone or one or more identity classifications along with one or more identity likelihood scores.

For example, a final identity of the potential object may be based on a voting rule or an algorithm such that if there are three identity classifications, which are based on data from three different sensors, and two of the three identity classifications agree that the object is a human, the security system may identify the object as human. In another embodiment, the final identity of the potential object may be based on identity likelihood scores. For example, the final identity of the potential object may be based on a rule that the identity classification with the highest identity likelihood score will be determined to be the final identity of the potential object. Alternatively, threshold rules may be applied such that the security and automation system identifies potential objects based on the identity likelihood scores exceeding a threshold level.

If a potential object is determined to be human, the security and automation system may determine whether the human is a known person or an unknown person. To do this, the security and automation system may have access to a database containing a library of data associated with known people. This data may include images, retinal data, gait data, posture data, height, weight, etc. for one or more known people. The security and automation system may compare data received from one or more sensors to the data contained in this library to determine whether the human is a known person.

In addition to determining whether the human is a known or unknown person, the security and automation system may also determine whether the person is engaging in a suspicious behavior. These suspicious behaviors may include crawling, creeping, running, looking over a shoulder, picking up a package, touching a car, opening a car door, peaking into a car, opening a mailbox, opening a door, opening a window, holding a weapon, screaming, or throwing something.

Thus, the security and automation system may be configured to identify a potential object, determine (if the object is determined to be human) whether the human is a known or unknown person, and determine whether the person is engaging in suspicious behavior. Once a potential object is detected, identified, and/or a threat level is determined, the security and automation system may perform a security action. The security action may include playing a sound or turning on a light or some other device. If the object is determined to be an animal, for example, a light may be turned or a sound played to encourage the animal to move away from the structure. The sound may be determined based on a subcategory to which the animal belongs. For example, if the animal detected is determined to be a racoon, the sound of a growling dog may be played.

Similarly, if the object is determined to be a human, the human is not a known person, and is engaging in a suspicious behavior, the security and automation system may play a voice message to encourage the person to leave and deter any damage or other vandalism to the property. In some embodiments, the message played may be associated with the suspicious behavior or a feature of the person. For example, if the person is looking into the window of a car, the voice message may ask the person why they are looking into the car. Alternatively, if the suspicious person is wearing a hat, the voice message may address the person and reference the fact that he or she is wearing a hat.

In some embodiments, the security and automation system may require a person to remain in an evaluation field or ROI for a certain period of time before a security action is taken. This amount of time, however, may be adjusted based on the behavior of the person. For example, if the person is engaging in a suspicious behavior, the security and automation system may shorten the period of time before a security action is taken. Alternatively, if the person is engaging in a behavior that is not suspicious, the security and automation system may lengthen the period of time before a security action is taken. In this embodiment, the security action taken may also be less aggressive than security actions taken when behavior is deemed to be suspicious.

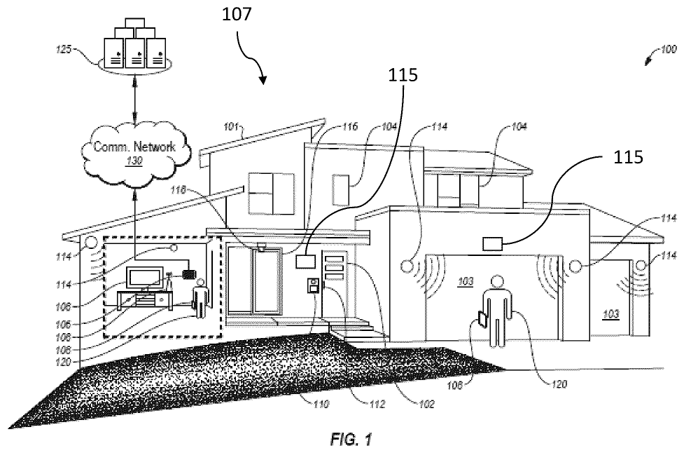

Turning to the figures, FIG. 1 illustrates a security and automation system 100 in which the present systems and methods may be implemented. The security and automation system 100 may include a building 101, or parts of the building 101 within an environment 107. In some embodiments, environment may include the building 101 and an outdoor area surrounding the building 101, or any number of different structures. The building 101 could be a residence such as a home. Alternatively, the building 101 could be a commercial or industrial building such as an office, a warehouse, a garage, and the like. The building 101 includes various entryways, such as doors 102, garage doors 103, and windows 104. The environment 107 also includes users 120.

The security and automation system 100 may include a plurality of components. These components may include, but are not limited to, devices such as controllers 106, control panels, servers, computing devices 108 (e.g., personal computers or mobile devices), displays, gateways, cameras, processors, data collection devices, automation/security devices, devices with memory, alarm devices with audio and/or visual capabilities, sensors 114, heating, ventilation, and air conditioning (HVAC) devices (e.g., thermostats, fans, heaters, or the like), appliances, interface devices, smart switches, speakers, doorbells 110, smart locks 112, and output devices 115. These components may be communicatively coupled to each other through wired and/or wireless communication links. These communication links may include, for example, a communication network 130, which may include a Personal Area Network (PAN), a Local Area Network (LAN), a Metropolitan Area Network (MAN), a Wide Area Network (WAN), a Storage Area Network (SAN), a cellular network, the Internet, or some combination thereof.

The devices may communicate with a central server or a cloud computing system. The devices may form a mesh network. When the devices are connected to a common network, the security and automation system 100 may be an Internet of Things (“IoT”) system. Although the security and automation system 100 may include the building 101, the system may nonetheless be communicatively coupled to devices located outside of the building 101.

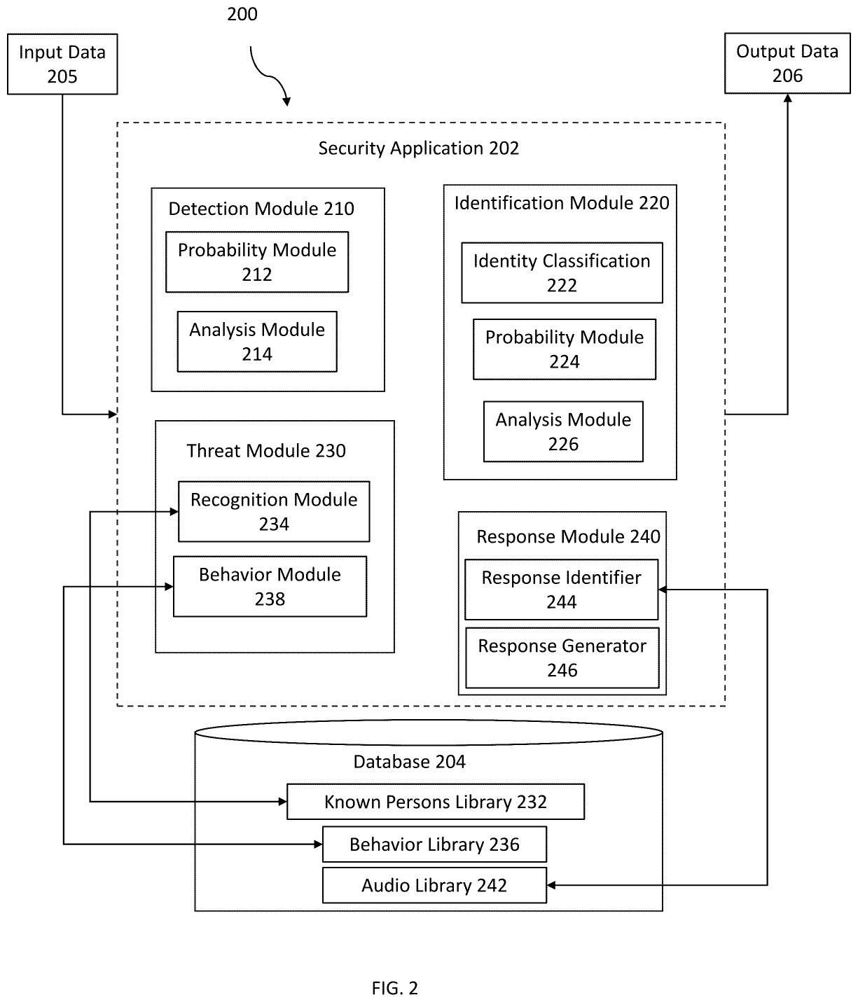

The devices of the security and automation system 100 may operate in various subsystems. Subsystems of the security and automation system 100 may include, but are not limited to, security, HVAC, lighting, electrical, fire control, and energy management systems. For example, as provided in more detail in connection with FIG. 2, the security and automation system 100 may include a security subsystem of devices, such as cameras, entry point sensors, smart locks, and security related output devices.

One or more devices of the security and automation system 100 may include data collection or user input capabilities. In some embodiments, these devices may be implemented to determine different behaviors of a user 120 within or immediately outside of the building 101, such as in the environment 107. These devices may include, but are not limited to, the sensors 114, cameras, tracking devices, feedback mechanisms, interfaces, switches, and microphones.

The security and automation system 100 may also include several devices capable of both collecting and outputting data through user interfaces. These interfaces may be accessed by the user 120 through an application configured for access through the web, a mobile device, and/or a tablet. The user 120 may also access them via a terminal or control panel mounted to a wall within the building 101 or to a piece of furniture. A control panel may interface with the communication network 130 through a first set of wired and/or wireless communication links.

Such interface devices may include, for example, one or more thermostats or interfaces placed at entryways. For example, entryway interfaces may include “smart doorbells” equipped with a sensor such as a camera, touch, or motion sensor. Entryway interfaces may detect a person's entry into or departure from the premises.

The security and automation system 100 may include other data collection devices such as devices that measure usage. For example, such devices may include those that measure energy usage, water consumption, or energy generation.

The security and automation system 100 may include a controller 106 that is configured to control one or more components of the security and automation system 100. The controller 106 may be any suitable computing device. The controller 106 may include both software and hardware components. For example, the controller 106 may include a processor, a user interface, a means of remote communication (e.g., a network interface, modem, gateway, or the like), a memory, a sensor, and/or an input/output port. The memory of the controller 106 may include instructions executable to perform various functions relating to automation and control of the security and automation system 100. In some embodiments, the controller 106 may communicate with other components of the security and automation system 100 over a common wired or wireless connection. The controller 106 may also communicate to outside networks, such as the Internet.

The controller 106 may be part of, integrated with, and/or in communication with a control panel, an IoT or smart device (e.g., a light bulb, a light switch, a doorbell 110, a smart lock 112, or the like), the sensors 114, a computing device 108, a remote computer 125 and/or server, output devices 115, and/or another electronic device. In some embodiments, the controller 106 may be integrated with and/or in communication with a remote service such as a remote computer 125 and/or server. For example, the controller 106 may be located remotely to the environment 107. The controller 106 may cause components of the security and automation system 100 to perform various actions based on input received from the sensors 114, the user 120, and/or on a certain setting. The controller 106 can cause various components of the security and automation system 100 to perform certain actions based on the occurrence of certain events. In some embodiments, the controller 106 can also receive instructions from a remote service provider. For example, if a remote service provider receives a notification that an intrusion has been detected within a home, the controller 106 may implement instructions from the remote service provider to activate various alarms within the home.

In some embodiments, the controller 106 may include several physical inputs. The user 120 may enter information using these inputs. Inputs may include, for example, devices such as keypads, keyboards, touch screens, buttons, switches, microphones, cameras, motion sensors, or any combination thereof. The user 120 may input data manually via, for example, a control panel, mobile computing device, desktop computing device, navigation system, gaming system, or appliance (e.g., television, HVAC, and the like). The user 120 may also input data or select controls via one or more data collection devices. For example, the user 120 may provide input via a microphone that they plan to leave the premises. The microphone can then communicate that information to the controller 106, which can then implement the appropriate settings based on that information. This may involve, for example, communicating with a smart lock device to lock a door. The user 120 may also provide input with instructions for the system to carry out a certain task. In that case, the controller 106 may directly influence an appropriate component of the security and automation system 100 to carry out that task. For example, if the user 120 provides an instruction to “turn the lights off,” the controller 106 can communicate those instructions to a smart light switch.

The controller 106 may also include an output display. This display may show the status of the security and automation system 100 or of various components of the security and automation system 100. In some embodiments, the output display may be part of a graphical user interface (“GUI”) through which the security and automation system 100 may also receive inputs from the user 120. The display and/or interface of the controller 106 may provide information to the user 120.

In some embodiments, the controller 106 may communicate with one or more devices, servers, networks, or applications that are external to the building 101. For example, the controller 106 may communicate with external devices through a cloud computing network. In some embodiments, these devices may process data received through one or more components of the security and automation system 100. The external devices may also connect to the Internet and support an application on a mobile or computing device through which the user 120 can connect to the security and automation system 100.

Other devices of the security and automation system 100 can also allow the user 120 to interact with the security and automation system 100 even if they are not in physical proximity to the environment 107 or any of the devices within the security and automation system 100. For example, a user 120 may communicate with a controller 106 or another device of the security and automation system 100 using a computer (e.g., a desktop computer, laptop computer, or tablet) or a mobile device (e.g., a smartphone). A mobile or web application or web page may receive input from the user 120 and to communicate with the controller 106 to control one or more devices of the security and automation system 100. Such a page or application may also communicate information about the device's operation to the user 120. For example, the user 120 may be able to view a mode of an alarm device of the security and automation system 100 and may change operational status of the device through the page or application.

In some embodiments, the controller 106 may be a computing device that is part of the security and automation system 100. For example, the controller 106 may be a personal computer, a laptop, a desktop computer, a server, or any combination thereof. The controller 106 can be a standalone device. For example, the controller 106 may be a smart speaker, speech synthesizer, virtual assistant device, or any combination thereof. The controller 106 may also be a control panel. The control panel may include a GUI to receive inputs from the user 120 and display information. The physical components of the control panel may be fixed to a structure within the environment 107. For example, the control panel including the controller 106 may be mounted to a wall of the building 101. The control panel may also be mounted to a piece of furniture. The controller 106 may also be a mobile and/or handheld device.

In certain embodiments, the controller 106 may be located remotely from the building 101. For example, the controller 106 may control components of the security and automation system 100 from a location of a service provider. The functions of the controller 106 may include functions that involve changing a status of a component of the security and automation system 100 or causing a component of the security and automation system 100 to perform a certain action.

The user 120 may also be able to view the status of the security and automation system 100 or of one or more components of the system through a display of the controller 106. Alternatively or additionally, the controller 106 may be able to communicate the status of the system to the user 120 through such means as audio outputs, lighting elements, messages and/or notifications transmitted to a mobile device of the user 120 (through an application, for example), or any combination thereof. The controller 106 can transmit messages or notifications to the user 120 regarding the status of one or more components of the security and automation system 100.

The controller 106 may allow the user 120 to control any component of the security and automation system 100. For example, the user 120 may activate an automated vacuum, fan element, lighting element, camera, sensor, alarm, or any combination thereof through the controller 106. The user 120 may also add components to the security and automation system 100 through the controller 106. For example, if the user 120 purchases a new fan that they would like to integrate into the security and automation system 100, they may do so by making inputs and/or selections through the controller 106.

The user 120 may also use the controller 106 to troubleshoot problems with the security and automation system 100 or components of the system. For example, if a heating element of the security and automation system 100 does not appear to be functioning properly, the user 120 may obtain a diagnosis of the problem by answering questions through the controller 106. Through the controller 106, the user 120 may provide instructions to take certain actions in response to a component of a system not functioning properly. In some embodiments, the user 120 may also communicate with one or more service providers through the controller 106. For example, the controller 106 may relay instructions to a device of the security and automation system 100 that is connected to a network to send a message to a service provider requesting a service to repair a malfunctioning component of the security and automation system 100.

Through the controller 106, the user 120 may change or set up schedules for the security and automation system 100. For example, the user 120 may desire that the premises be kept below a certain temperature at night and above a certain temperature during the day. Thus, the user 120 may create a schedule for the security and automation system 100 that reflects these preferences through the controller 106.

In some embodiments, the initial setup/configuration of the security and automation system 100 may be done through the controller 106. For example, when the security and automation system 100 is first implemented or installed within the premises, the user 120 may use the controller 106 to add and connect each component of the security and automation system 100 and to setup or configure their preferences. All or part of the configuration and initial setup process may be done automatically by the controller 106. For example, when a new component of the security and automation system 100 is detected, that component may be added to the security and automation system 100 automatically through the controller 106.

The controller 106 may monitor one or more components of the security and automation system 100. The controller 106 may also track and/or store data and/or information related to the security and automation system 100 and/or operation of the security and automation system 100. For example, the controller 106 may store data and/or information in a memory of the controller and/or in memory at one or more devices of the security and automation system 100. This data/information can include, for example, user preferences, weather forecasts, timestamps of entry to and departure from a structure, user interactions with a component of the security and automation system 100, settings, and other suitable data and information. The controller 106 may track and/or store this data automatically or in response to a request received from the user 120.

In one embodiment, the controller 106 may be communicatively coupled to one or more computing devices. The computing devices may include one or more of a desktop computer, a laptop computer, a tablet computer, a smart phone, a smart speaker (e.g., Amazon Echo®, Google Home®, Apple HomePod®), an IoT device, a security system, a set-top box, a gaming console, a smart TV, a smart watch, a fitness band or other wearable activity tracking device, an optical head-mounted display (e.g., a virtual reality headset, smart glasses, head phones, or the like), a High-Definition Multimedia Interface (“HDMI”) or other electronic display dongle, a personal digital assistant, a digital camera, a video camera, or another computing device comprising a processor (e.g., a central processing unit (“CPU”), a processor core, a field programmable gate array (“FPGA”) or other programmable logic, an application specific integrated circuit (“ASIC”), a controller, a microcontroller, and/or another semiconductor integrated circuit device), a volatile memory, and/or a non-volatile storage medium, a display, a connection to a display, and/or the like.

In one embodiment, the computing devices include applications (e.g., mobile applications), programs, instructions, and/or the like for controlling one or more features of the controller 106. The computing devices, for instance, may be configured to send commands to the controller 106, to access data stored on or accessible via the controller 106, and/or the like. For example, a smart phone may be used to view photos or videos of the building 101 via the controller 106, to view or modify temperature settings via the controller 106, and/or the like. In such an embodiment, the controller 106 may include an application programming interface (“API”), or other interface, for accessing various features, settings, data, components, elements, and/or the like of the controller 106, and the security and automation system 100 in general.

The security and automation system 100, in one embodiment, includes the sensors 114 that are communicatively coupled to the controller 106. As used herein, the sensors 114 may be devices that are used to detect or measure a physical property and record, indicate, or otherwise respond to it. Examples of the sensors 114 that may be part of the security and automation system 100 may include motion sensors, depth sensors, temperature sensors, pressure sensors, light sensors, entry sensors such as window or door sensors that are used to detect when a window or door (or other entryway) is open or closed, carbon monoxide detectors, smoke detectors, water leak sensors, microphones and/or other audio sensors used to detect and/or differentiate sounds such as breaking glass, closing doors, music, dialogue, and/or the like, infrared sensors, cameras, and/or the like.

In one embodiment, the security and automation system 100 may include various cameras that are located indoors and/or outdoors and are communicatively coupled to the controller 106. The cameras may include digital cameras, video cameras, infrared cameras, and/or the like. The cameras may be mounted or fixed to a surface or structure such as a wall, ceiling, soffit, and/or the like. The cameras may be moveable such that the cameras are not fixed or secured to a surface or structure, but can be moved (e.g., a baby monitor camera).

In one embodiment, the devices may include multiple sensors 114 or a combination of the sensors 114. For example, a smart doorbell may include an integrated camera, a light sensor, and a motion sensor. The light sensor may be used to configure camera settings of the camera, e.g., for light or dark image capture, and the motion sensor may be used to activate the camera, to send a notification that a person is at the door, and/or the like in response to the detected motion. Furthermore, the doorbell may include a physical button to activate a wired or wireless chime within the building, a notification or sound from a mobile application associated with the doorbell, and/or the like.

In one embodiment, the camera, the controller 106, the local and/or remote computing device 125, the mobile device, and/or the like, may include image processing capabilities for analyzing images, videos, or the like that are captured with the cameras. The image processing capabilities may include object detection, facial recognition, gait detection, and/or the like. For example, the controller 106 may analyze or process images from the camera, e.g., a smart doorbell, to determine that a package is being delivered at the front door/porch. In other examples, the controller 106 may analyze or process images to detect a child walking within a proximity of a pool, to detect a person within a proximity of a vehicle, to detect a mail delivery person, to detect animals, and/or the like. In certain embodiments, the controller 106 may utilize artificial intelligence and machine learning image processing methods for processing and analyzing image and/or video captures.

In one embodiment, the controller 106 is connected to various IoT devices. As used herein, an IoT device may be a device that includes computing hardware to connect to a data network and communicate with other devices to exchange information. In such an embodiment, the controller 106 may be configured to connect to, control (e.g., send instructions or commands), and/or share information with different IoT devices. Examples of IoT devices may include home appliances (e.g., stoves, dishwashers, washing machines, dryers, refrigerators, microwaves, ovens, or coffee makers), vacuums, garage door openers, thermostats, HVAC systems, irrigation/sprinkler controller, television, set-top boxes, grills/barbeques, humidifiers, air purifiers, sound systems, phone systems, smart cars, cameras, projectors, and/or the like. In one embodiment, the controller 106 may poll, request, receive, or the like information from the IoT devices (e.g., status information, health information, power information, and/or the like) and present the information on a display on the controller 106, via a mobile application, and/or the like.

In one embodiment, the IoT devices include various lighting components includes smart light fixtures, smart light bulbs, smart switches, smart outlets, exterior lighting controllers, and/or the like. For instance, the controller 106 may be communicatively connected to one or more of the various lighting components to turn lighting devices on/off, change different settings of the lighting components (e.g., set timers, adjust brightness/dimmer settings, adjust color settings, and/or the like). In further embodiments, the various lighting settings may be configurable using a mobile application, via the controller 106, running on a smart device.

In one embodiment, the IoT devices include one or more speakers within the building. The speakers may be stand-alone devices such as speakers that are part of a sound system, e.g., a home theatre system, a doorbell chime, a Bluetooth speaker, and/or the like. In certain embodiments, the one or more speakers may be integrated with other devices such as televisions, lighting components, camera devices (e.g., security cameras that are configured to generate an audible noise or alert), and/or the like.

In one embodiment, the various components of the security and automation system 100, e.g., the controller 106, the cameras and other devices, the IoT devices, and/or the like, are communicatively connected over wired or wireless links of the communication network 130. The communication network 130, in one embodiment, includes a digital communication network that transmits digital communications. The communication network 130 may include a wireless network, such as a wireless cellular network, a local wireless network, such as a Wi-Fi network, a Bluetooth® network, a near-field communication (“NFC”) network, an ad hoc network, and/or the like. The communication network 130 may include a WAN, a SAN, a LAN (e.g., a home network), an optical fiber network, the internet, or other digital communication network. The communication network 130 may include two or more networks. The communication network 130 may include one or more servers, routers, switches, and/or other networking equipment. The communication network 130 may also include one or more computer readable storage media, such as a hard disk drive, an optical drive, non-volatile memory, RAM, or the like.

The wireless network may be a mobile telephone network. The wireless network may also employ a Wi-Fi network based on any one of the Institute of Electrical and Electronics Engineers (“IEEE”) 802.11 standards. Alternatively, the wireless network may include a Bluetooth® connection. In addition, the wireless network may employ Radio Frequency Identification (“RFID”) communications including RFID standards established by the International Organization for Standardization (“ISO”), the International Electrotechnical Commission (“IEC”), the American Society for Testing and Materials® (ASTM®), the DASH7™ Alliance, and/or EPCGlobal™.

In one embodiment, the wireless network may employ a ZigBee® connection based on the IEEE 802 standard. In such an embodiment, the wireless network includes a ZigBee® bridge. In one embodiment, the wireless network employs a Z-Wave® connection as designed by Sigma Designs®. Alternatively, the wireless connection may employ an ANT® and/or ANT+® connection as defined by Dynastream® Innovations Inc. of Cochrane, Canada.

In one embodiment, the security and automation system 100 is configured to provide various functions via the connections between the different components of the security and automation system 100. In one embodiment, the security and automation system 100 may automate various routines and processes. The routines may be learned over time, e.g., based on the occupancy of the users 120, the activities of the users 120, and/or the like, and/or may be programmed or configured by the users 120 (e.g., via a digital automation platform such as If This Then That (“IFTTT”)).

For example, the security and automation system 100 may automate a “wake-up routine” for the user 120. The “wake-up routine” may define a process flow that includes starting a coffee maker, activating a water heater and/or turning on a bath/shower faucet, turning up the temperature in the building via a thermostat, triggering automated blinds/window coverings to open, turning on a television and setting it to a particular channel, and/or activating/deactivating/changing settings of lights. In such an embodiment, the process flow may be defined using an interface on the controller 106 and/or via a mobile application, and the controller 106 may coordinate communications, including instructions, commands, or signals, via a data network, to trigger different functions of the IoT devices that are included in the process flow.

In one embodiment, the security and automation system 100 may be configured to perform various smart home functions, e.g., automated functions to assist the user 120 within the building 101. For example, an entry sensor on a front door that the controller 106 is communicatively connected to may detect that the door is opened, indicating the presence of a person within the building 101. In response to the front door sensor indicating the presence of a person, the controller 106 may trigger one or more lights, e.g., via a smart light switch and/or a smart light fixture/bulb, to turn on.

In another example, one or more entry sensors may indicate that doors and/or windows are opened frequently, which may cause the loss of heated or cooled air and/or may introduce particulates into the air within the building 101. Accordingly, in response to the indication from the one or more entry sensors, the controller 106 may change settings of the HVAC system (e.g., increase the volume of the HVAC system, change the temperature or humidity settings of the HVAC system, and/or the like), and may activate an air purifier within the home.

In another example, the controller 106 may receive a notification from a smart phone that the user 120 is within a predefined proximity or distance from the home, e.g., on their way home from work. Accordingly, the controller 106 may activate a predefined or learned comfort setting for the home, including setting a thermostat at a certain temperature, turning on certain lights inside the home, turning on certain lights on the exterior of the home, turning on the television, turning a water heater on, and/or the like.

In some embodiments, the security and automation system 100 may be a home security system. In such an embodiment, the security and automation system 100 may prevent, detect, deter, or mitigate the effects of intrusions, crimes, natural disasters, or accidents occurring within the environment 107. The security and automation system 100 may carry out these functions in accordance with predetermined preferences of the user 120.

The controller 106 can allow the user 120 to change a status or mode of the security and automation system 100. For example, if the security and automation system 100 has alarm and security capabilities, the user 120 can use the controller 106 to change the status of the premises from “armed” to “disarmed” or vice versa. Other examples of statuses of the security and automation system 100 that can be affected through the controller 106 include, but are not limited to, “armed but at home,” “armed stay,” “armed and away,” “away,” “at home,” “sleeping,” “large gathering,” “nanny mode,” and/or “cleaning company here.” These statuses may reflect a user's preferences for how the security and automation system 100 should operate while that status is activated.

The security and automation system 100 may detect a potential intruder through one or more of its devices. The presence of a potential intruder may be communicated to one or more additional devices. The security and automation system 100 may do this by monitoring areas that are outside of the building 101 or even outside of the environment 107. The security and automation system 100 can include interfaces that that communicate such threats to the user 120. Detection devices of the security and automation system 100 may also communicate these threats to a device of the security and automation system 100 capable of relaying the message to the user 120. For example, messages may be received by the user 120 from the security and automation system 100 through one or more mobile devices.

The security and automation system 100 embodied as a security system may include, but is not limited to, security devices such as smart locks, cameras, sensors 114, alarm devices, output devices such as lights and speakers, and garage door controls. The security and automation system 100 may provide automated, centralized control of such devices.

The security and automation system 100 may include devices with both hardware and software components. For example, the security and automation system 100 may include a smart lock that has hardware components with the capability to lock or unlock a door and software components with the capability to receive instructions from a mobile device through an application.

The security and automation system 100 may include emergency response capabilities. For example, the security and automation system 100 may be connected to a cellular, radio, or computer network that serves to notify authorities and/or emergency personnel when a crime, natural disaster, or accident has occurred within the building 101. In some embodiments, security and automation system 100 may communicate directly with authority and/or emergency services in such an event. The security and automation system 100 may be monitored by an offsite monitoring service. The offsite monitoring service may include personnel who can receive notifications of and/or monitor events taking place within the building 101 and contact emergency services when sign of such an event appear.

FIG. 2 illustrates components of a security subsystem 200 of a security and automation system, such as the security and automation system 100 of FIG. 1. The security subsystem 200 includes a security application 202 and a database 204. The security application 202 may be part of a controller, such as the controller 106 illustrated in FIG. 1. Alternatively, the security application 202 may be installed on a mobile device, such as a smart phone, or on a remote security server.

In some embodiments, the security application 202 may be configured to process, and/or otherwise use input data 205 to detect one or more objects (e.g., people, animals, vehicles, shipping packages or other deliveries, or the like), one or more events (e.g., arrivals, departures, weather conditions, crimes, property damage, or the like), determine whether the object presents a threat and, through output data 206, perform an appropriate action in response to the object.

The input data 205 may be received from multiple sources and may include data from one or more sensors. For example, the input data 205 may be received from an image sensor, such as a camera, that includes one or more images. In another embodiment, a sensor may include a depth sensor, such as a RADAR device, an infrared sensor, a direct or indirect ToF device, a structured light sensor, or a LiDAR device. In this embodiment, the input data 205 from the depth sensor may include movement of a potential object, a distance between the potential object and the sensor, a vibration of the potential object, a speed of the potential object, or a size of the potential object. In another embodiment, a sensor may include an audio sensor, such as a microphone, and the input data 205 from the audio sensor may include one or more sounds.

Based on the input data 205, a detection module 210 within the security application 202 may determine whether the potential object is within an evaluation field of the sensors (e.g., a geographic area, a property, a building, a room, a field of view of a camera or other sensor, or the like). In addition or alternatively, the detection module 210 may determine whether the potential object is within a ROI of the evaluation field. A ROI may include a part or portion of an evaluation field.

The detection module 210 may determine whether the potential object actually exists in the evaluation field and/or the ROI. To do this, a probability module 212 within the detection module 210 may determine, separately for each sensor from which data is received, a likelihood that the potential object actually exists in the evaluation field. For example, if the security application 202 receives audio data from a microphone, the probability module 212 may evaluate this audio data to determine a likelihood that that there is actually an object in the evaluation field of the microphone using sound analytics, machine learning and/or other artificial intelligence, or the like. If the security application 202 also receives image data from an image sensor such as a camera, the probability module 212 may also evaluate this image data to determine a likelihood that that there is actually an object in the evaluation field of the camera using image processing, image detection, machine learning and/or other artificial intelligence, or the like. If the security application 202 receives depth data from a depth sensor, the probability module 212 may also evaluate the depth data to determine a likelihood that that there is actually an object in the evaluation field of the depth sensor based on a location for the potential object, a speed of the potential object, a proximity of the potential object to another object and/or location, an interaction of the potential object (e.g., touching and/or approaching another object or location), or the like.

An analysis module 214 within the detection module 210 may then evaluate the likelihoods identified by each of the separate sensors to determine whether an object is actually within the evaluation field (e.g., to perform an action relative to the potential object within the evaluation field, or the like). For example, in one embodiment, the analysis module 214 may use a voting algorithm and determine that an object is actually present within the evaluation field in response to a majority of sensors determining that the object is present within the evaluation field (e.g., two or more sensors out of three, three or more sensors out of four, or the like).

In another embodiment, the analysis module 214 may require that all sensors corresponding to the evaluation field determine that an object is present within the evaluation field to determine that an object is actually present (e.g., a more conservative and/or less aggressive determination than the voting algorithm). In yet another embodiment, the analysis module 214 may determine that an object is actually present within the evaluation field in response to at least one sensor determining that the object is present within the evaluation field (e.g., a less conservative and/or more aggressive determination than the voting algorithm).

In some embodiments, the analysis module 214 may combine confidence metrics indicating likelihoods that an object is actually within the evaluation field from multiple sensors (e.g., averaging confidence metrics, selecting a median confidence metric, or the like) to determine whether the combination of confidence metrics indicates a presence of the object within the evaluation field. While in some embodiments the analysis module 214 may be configured to evaluate probabilities identified by different sensors separately, in other embodiments, the analysis module 214 may be configured to correlate and/or analyze data from multiple sensors together.

Once the detection module 210 has determined the presence of an actual object in an evaluation field, the identification module 220 may determine an identity of the object. In one embodiment, the detection module 210 may detect the presence of the object based on data from a first sensor and the identification module 220 may identify and/or confirm an identity of the object using a different sensor. In this manner, in certain embodiments, the security application 202 may detect and/or identify the object more accurately using multiple sensors than may be possible using data from a single sensor. In this embodiment, the first and second sensors may be the same or different types of sensors. For example, the detection module 210 may detect the present of the object based on data from an image sensor and the identification module 220 may identify the object using a depth sensor.

To identify the object detected by the detection module 210, an identity classification module 222 within the identification module 220 may determine an identity classification separately for each sensor from which data is received. The identity classification may determine a class to which the object belongs. For example, the object may be classified as a human, an animal, or a nonliving object. If the detection module 210 determines that the object does not exist, the identity classification module 222 may confirm this and classify the object as a lack of an object.

In addition to identifying a classification, the probability module 224 may also determine, separately for each sensor from which data is received, an identity likelihood score for the class of an object identified. An identity likelihood score may provide a confidence level that the identity classification is accurate. The identity likelihood score may be presented in the form of a number, such as a percentage, or another representation of a confidence level. For example, the probability module 224 may identify an identity likelihood score that the object is a human, an animal, or some other nonliving object, such as a box or a car or a parcel.

In one embodiment, if the security application 202 receives audio data from an audio sensor such as a microphone, the probability module 224 may evaluate this audio data to determine an identity likelihood score that the object is a human, an animal, or a nonliving object using sound analytics, machine learning and/or other artificial intelligence. If the security application 202 receives image data from an image sensor such as a camera, the probability module 224 may evaluate this image data to determine an identity likelihood score that the object is a human, an animal, or a nonliving object using image processing, image detection, machine learning and/or other artificial intelligence. If the security application 202 receives depth data from a depth sensor, the probability module 224 may evaluate this depth data to determine an identity likelihood score that the object is a human, an animal, or a nonliving object based on a location of the object, a speed of the object, a proximity of the object to another object and/or location, and/or an interaction of the object (e.g., touching and/or approaching another object or location).

An analysis module 226 within the identification module 220 may then evaluate the identity classifications and, in some embodiments, identity likelihood scores determined from the data received from each of the sensors. The analysis module 226 may evaluate these determinations to determine a final identity of the potential object. A number of different evaluation models may be implemented by the analysis module 226 to determine a final identity of a potential object. For example, in one embodiment, the analysis module 226 may use a voting algorithm to determine that the potential object is a human in response to a majority of sensors classifying the potential object as human (e.g., two or more sensors out of three, three or more sensors out of four, or the like).

In another embodiment, the analysis module 226 may determine the identity of an object in response to all sensors determining uniformly that the object has the same identity (e.g., a more conservative and/or less aggressive determination than a voting algorithm). In yet another embodiment, the analysis module 226 may determine the identity of an object in response to at least one sensor determining the identity of the object (e.g., a less conservative and/or more aggressive determination than a voting algorithm).

In some embodiments, the analysis module 226 may combine confidence metrics indicating likelihoods an object's identity from multiple sensors (e.g., averaging confidence metrics, selecting a median confidence metric, or the like) to determine whether the combination establishes an identity of the object. In some embodiments, the analysis module 226 may be configured to correlate and/or analyze data from multiple sensors together, based on data from a plurality of sensors.

In another embodiment, the analysis module 226 may determine the final identity of the object based on one or more identity likelihood scores that exceed a threshold level. For example, the input data 205 may be received from an image sensor, a depth sensor, and an audio sensor. The image sensor may classify the identity of the object as animal with an identity likelihood score of 70%. The depth sensor may classify the identity of the object as human with an identity likelihood score of 80%. The audio sensor may classify the identity of the object as animal with an identity likelihood score of 50%.

In this example, the analysis module 226 may determine that the final identity of the object is either an animal or a human, depending on the evaluation model applied. For example, in some embodiments, the analysis module 226 may determine the identity of the object based on the highest identity likelihood score. In this embodiment, the security application 202 would identify the object as human because the depth sensor—which identifies the object as human—has the highest identity likelihood score. In other embodiments, the analysis module 226 may determine the identity of the object based on a majority of the sensor identity classifications. In this embodiment, the analysis module 226 would identify the object as animal because the image and audio sensors—which identify the object as animal—constitute the majority.

If the identification module 220 determines that the object in an evaluation field is human, a threat module 230 may determine whether or not the person presents a threat. To do this, a recognition module 234 may first determine whether the person is known or unknown. To determine whether a person is known, the recognition module 234 may access a known persons library 232, which may be stored within the database 204. The known persons library 232 may contain data associated with known people. For example, if the security application 202 is in use at a house, data associated with the residents of the house, friends of the residents, family of the residents, frequent visitors such as maintenance personnel parcel delivery personnel, etc. may be stored in the known persons library 232. If the security application 202 is in use at a warehouse, data associated with the people that work at the warehouse or frequently visit the warehouse may be stored in the known persons library 232.

The data in the known person library 232 may include any data that can be used to identify a person. For example, the data may include images such as facial and retinal scans, height data, movement data such as gait, posture data, sound data including a person's voice.

To determine whether a person is known, the recognition module 234 may obtain data from one or more of the sensors and compare it to data in the known persons library 232. For example, the recognition module 234 may compare image data received from an image sensor with image data for known people stored in the known persons library 232. The recognition module 234 may compare movement data received from a depth sensor with movement data for known people stored in the known persons library 232. The recognition module 234 may compare sound data received from an audio sensor with sound data for known people stored in the known persons library 232. Based on these comparisons, the recognition module 234 may determine whether a person is known or unknown. This determination may be based on artificial intelligence trained models or other standard person recognition methods techniques.

In some embodiments, the recognition module 234 may identify and store image data of persons that frequently visit and are invited into the location of the security application 202. The recognition module 234 may periodically present these images to a security account manager and ask whether the persons should be included within the known persons library 232.

If the recognition module 234 does not identify the detected person as a known person, the recognition module 234 may identify the detected person as an unknown person. A behavior module 238 may determine whether the person is engaged in one of a predefined set of suspicious or threatening behaviors and/or patterns. Examples of suspicious or threatening behaviors include crawling on the ground, creeping, running, picking up a package, touching a car, getting close to a car, opening a car door, peaking into a car, opening a mailbox, opening a door, opening a window, throwing something, or any other suspicious or threatening behavior.

To determine whether a person is engaged in one of a predefined set of suspicious or threatening behaviors and/or patterns, the behavior module 238 may access a behavior library 236, which may also be stored within the database 204. In some embodiments, the behavior library 236 may store the predefined sets of suspicious or threatening behaviors/patterns.

The behavior module 238 may obtain sensor data to determine whether the person's behavior falls within one of the predefined sets of suspicious or threatening behaviors/patterns. This data may include any data that can be used to identify a person's behavior. For example, the data may include image data, movement data, and sound data. The behavior module 238 may compare this data to the behavior data stored in the behavior library 236. For example, the behavior module 238 may compare the image data received from an image sensor with the image data associated with suspicious or threatening behavior stored in the behavior library 236. The behavior module 238 may compare the movement data received from a depth sensor with the movement data associated with suspicious or threatening behavior stored in the behavior library 236. The behavior module 238 may compare the sound data received from an audio sensor with the sound data associated with suspicious or threatening behavior stored in the behavior library 236. Based on these comparisons, the behavior module 238 may determine whether the person is engaged in the suspicious or threatening behavior. This determination may also be based on artificial intelligence trained models.

In some embodiments, the behavior library 236 may also store one or more predefined sets of safe behaviors/patterns. These safe behaviors may include leaving a package, knocking on the door, kids playing, mailman leaving mail. The behavior module 238 may further detect medical situations For example, the depth data from a depth sensor may detect if the person within the evaluation field falls. The behavior library 236 may detect physiological parameters, such as heart rates and breathing patterns. Further, the threat module 230 may detect the presence of certain objects or sounds. For example, the sound of a gunshot may be detected by a microphone and the threat module 230 may determine that there is a gun close by.

Based on determinations made by one or more of the detection module 210, the identification module 220, and the threat module 230, a response module 240 may identify and implement an appropriate action or response. The response module 240, in response to determining the presence of the object within the evaluation field, may issue one or more instructions in the form of output data 206 to one or more devices to implement the instructions. For example, the response module 240 may perform an action including emitting one or more sounds from a speaker, turning on a light, turning off a light, directing a lighting element toward the object, opening or closing a garage door, turning a sprinkler on or off, turning a television or other smart device or appliance on or off, activating a smart vacuum cleaner, activating a smart lawnmower, and/or performing another action based on the object, the determined identity of the object, or the like.

In some embodiments, the response module 240 may perform an action that is selected to deter a detected human (e.g., to deter the human from the evaluation field and/or property, to deter the human from damaging property and/or committing a crime) or to deter a detected animal. In one embodiment, in response to detecting and identifying the object as human (e.g., an unknown human), the response module 240 may perform an action to deter the human. The response module 240 may include a response identifier 244 that is configured to identify one or more appropriate sounds to deter a detected object, such as a person or an animal, from an area around a building, property, and/or other object (such as a car or a parcel). The response identifier 244, in certain embodiments, may vary sounds over time, dynamically layer and/or overlap sounds, and/or generate unique sounds, to preserve a deterrent effect of the sounds over time and/or to prevent those being deterred from becoming accustomed to the same sounds used over and over.

To determine an appropriate sound to play, the response identifier 244 may have access to an audio library 242, which may also be stored within the database 204. The audio library 242 may store a plurality of different sounds and/or a set of dynamically generated sounds so that the response identifier 244 may vary the different sounds over time, not using the same sound often. In some embodiments, varying and/or layering sounds allows a deterrent sound to be more realistic and/or less predictable. One or more of the sounds may be selected to give a perception of human presence, a perception of a human talking over an electronic speaker device, or the like which may be effective at preventing crime and/or property damage.

For example, the audio library 242 may include audio recordings and/or dynamically generated sounds of one or more, male and/or female voices saying different phrases, such as for example, a female saying “hello?”, a female and male together saying “can we help you?”, a male with a gruff voice saying, “get off my property” and then a female saying “what's going on?”, a female with a country accent saying “hello there”, a dog barking, a teenager saying “don't you know you're on camera?”, and/or a man shouting “hey!” or “hey you!”, or the like.

In one embodiment, the response module 240 also includes a response generator 246 that may dynamically generate one or more sounds (e.g., using machine learning and/or other artificial intelligence, or the like) with one or more attributes that vary from previously played sounds. For example, the response generator 246 may generate sounds with different verbal tones, verbal emotions, verbal emphases, verbal pitches, verbal cadences, verbal accents, or the like so that the sounds are said in different ways, even if they include some or all of the same words. In some embodiments, the response generator 246 and/or a remote computer may train machine learning on reactions of previously detected humans in other areas to different sounds and/or sound combinations (e.g., improving sound selection and/or generation over time).

The response module 240 may combine and/or layer these sounds (e.g., primary sounds), with one or more secondary, tertiary, and/or other background sounds, which may comprise background noises selected to give an appearance that a primary sound is a person speaking in real time, or the like. For example, a secondary, tertiary, and/or other background sound may include sounds of a kitchen, of tools being used, of someone working in a garage, of children playing, of a television being on, of music playing, of a dog barking, or the like. The response module 240, in some embodiments, may be configured to combine and/or layer one or more tertiary sounds with primary and/or secondary sounds for more variety, or the like. For example, a first sound (e.g., a primary sound) may comprise a verbal language message and a second sound (e.g., a secondary and/or tertiary sound) may comprise a background noise for the verbal language message (e.g., selected to provide a real-time temporal impression for the verbal language message of the first sound, or the like).

In this manner, in various embodiments, the response module 240 may intelligently track which sounds and/or combinations of sounds have been played, and in response to detecting the presence of a human, may select a first sound to play that is different than a previously played sound, may select a second sound to play that is different than the first sound, and may play the first and second sounds at least partially simultaneously and/or overlapping. For example, the response module 240 may play a primary sound layered and/or overlapping with one or more secondary, tertiary, and/or background sounds, varying the sounds and/or the combination from one or more previously played sounds and/or combinations, or the like.

The response module 240, in some embodiments, may select and/or customize an action based at least partially on one or more characteristics of the object. For example, the response module 240 may determine one or more characteristics of the object based on audio data, image data, depth data, and/or other data from the sensors. One or more of the detection module 210, the identification module 220, and the threat module 230 may determine a characteristic, such as a type or color of an article of clothing being worn by a person, a physical characteristic of a person, an object being held by a person, or the like. The response generator 246 may customize an action and/or audio response based on a determined characteristic, such as by including a description of the characteristic in an emitted sound (e.g., “hey you in the blue coat!” or “you with the umbrella!”, or the like). In another embodiment, if the identification module 220 determines that the potential object is a racoon, the response identifier 244 may identify within the audio library 242, or the response generator 246 may generate a sound of a dog growling or another sound to deter the racoon.

The response module 240, in one embodiment, may escalate and/or otherwise adjust an action over time and/or may perform a subsequent action in response to determining (e.g., based on data and/or determinations from one or more sensors,) that an object (e.g., a human, an animal, or the like) remains in an area after performing a first action (e.g., after expiration of a timer, or the like). For example, the response module 240 may increase a volume of a sound, emit a louder and/or more aggressive sound (e.g., a siren, a warning message, an angry or yelling voice, or the like), increase a brightness of a light, introduce a strobe pattern to a light, and/or otherwise escalate an action and/or subsequent action. In certain embodiments, the response module 240 may perform a subsequent action (e.g., an escalated and/or adjusted action) relative to an object in response to determining that movement of the object satisfies a movement threshold based on subsequent depth data from a depth sensor (e.g., subsequent depth data indicating the object is moving and/or has moved at least a movement threshold amount closer to the depth sensor, closer to a structure, closer to another identified and/or predefined object, or the like).

For example, if an unknown person has entered a restricted area/zone, the response module 240 may expedite a deter action, reduce a waiting/monitoring period after detecting the human and before performing a deter action. In some embodiments, the security application 202 may enter a different state (e.g., an armed mode, a security mode, an away mode, or the like) in response to detecting a human in a predefined restricted area/zone or other ROI (e.g., passing through a gate and/or door, entering an area/zone previously identified by an authorized user as restricted, entering an area/zone not frequently entered such as a flowerbed, shed or other storage area).

The response module 240 may also be configured to activate one or more cameras that are within a proximity of a detected motion based on data from a sensor to capture images and/or videos of the detected movement. As provided above, the identification module 220 may use image processing techniques to process the captured images/videos to determine if the detected movement is a person, and, if so, the threat module 230 may attempt to identify the person. If the threat module 230 cannot identify the person, or if the person is identified as an unauthorized person, the response module 240 may trigger various enhanced security measures to deter and/or react to the security threat.

For example, the response module 240 may communicate with one or more smart lighting devices to activate one or more interior and/or exterior lights. In another example, the response module 240 may communicate with one or more speaker devices to generate a sound such as a whistle, alarm, of the like. In such an embodiment, sounds may be generated within the home to simulate occupancy of the home, e.g., sounds such as people talking, music, television sounds, water running, glass breaking, children playing, and/or the like. Other sounds may be generated outside the home to simulate outdoor activities, e.g., sounds such as tools clanking or other garage noises, people walking outside, and/or the like.

The response module 240, in further embodiments, may send output data 206 in the form of notifications, alerts, and/or other messages to designated persons/parties to indicate the potential security threat. For example, the response module 240 may send a push notification, a text message, a social media message, an email message, a voice message, and/or the like to an owner of a home or business, to emergency services, e.g., police department, and/or the like. In one embodiment, the output data 206 may include details associated with the potential security threat including a timestamp, images/videos of the person, the location (e.g., the address), and/or the like.

In addition, the response module 240 may combine the playing of one or more sounds and/or sound combinations with one or more automated actions (e.g., smart home and/or home security system automated actions) for a building associated with the monitored area, such as partially opening a garage door (e.g., a few inches) and then closing, turning a light on or off in or around the building, turning a television on or off, activating a smart vacuum cleaner or other appliance, turning one or more sprinklers on or off, or activating a smart lawnmower. The response identifier 244 or the response generator 246 may select and/or generate a sound and/or combination of sounds to correspond to one or more automated actions. For example, the response module 240 may play a sound of a voice saying “I'm going to open the garage and come out there” and at least partially open a garage door, or may play a sound of a voice saying “honey, turn on that light” and turn on a light, or may play a sound of a voice saying “you'd better leave or I'll turn on the sprinklers” and turn on one or more sprinklers, thereby disclosing to the detected person that the one or more automated actions are to occur and lending believability to both the sound and the automated action.

The response module 240, in certain embodiments, may group sounds and/or sound combinations based on a setting, mode, and/or state of the security subsystem or building. For example, the response module 240 may use different sounds and/or different modes if a home alarm and/or security system is armed or disarmed (e.g., using a control panel, a computing device, an automated determination, or the like), if there are people in the building or if the building is empty, if a sensor detects children playing in a backyard, if only children are home, or the like.

The response module 240 may select a sound and/or sound combination to play based on a detected behavior and/or other characteristic of a detected human. For example, the response module 240 may play a first sound in response to detecting an unknown person at a first predefined distance (e.g., 10 feet away), play a second sound in response to detecting the unknown person at a second predefined distance (e.g., 5 feet away), and play a third sound in response to detecting the unknown person reaching, touching, and/or interacting with a predefined object, such as a package, a vehicle, a door, or the like.

In a further embodiment, the response module 240 may perform a welcoming action and/or another predefined action in response to recognizing a known human (e.g., an identity matching a profile of an occupant or known user in a library, based on facial recognition, based on bio-identification, or the like) such as executing a configurable scene for a user, activating lighting, playing music, opening or closing a window covering, turning a fan on or off, locking or unlocking a door, lighting a fireplace, powering an electrical outlet, turning on or play a predefined channel or video or music on a television or other device, starting or stopping a kitchen appliance, starting or stopping a sprinkler system, opening or closing a garage door, adjusting a temperature or other function of a thermostat or furnace or air conditioning unit, or the like.

Modifications, additions, or omissions may be made to the security application 202 without departing from the scope of the present disclosure. For example, the security application 202 may include additional components similar to the components illustrated in FIG. 2 that each may be configured similarly to the components illustrated in FIG. 2. Further, in some embodiments, the functionality of the security application 202 may be spread across two or more separate devices. For example, some of the functionality of the security application 202 may be performed on a mobile device such as a smart phone while other functions of the security application 202 may be performed on a remote server.

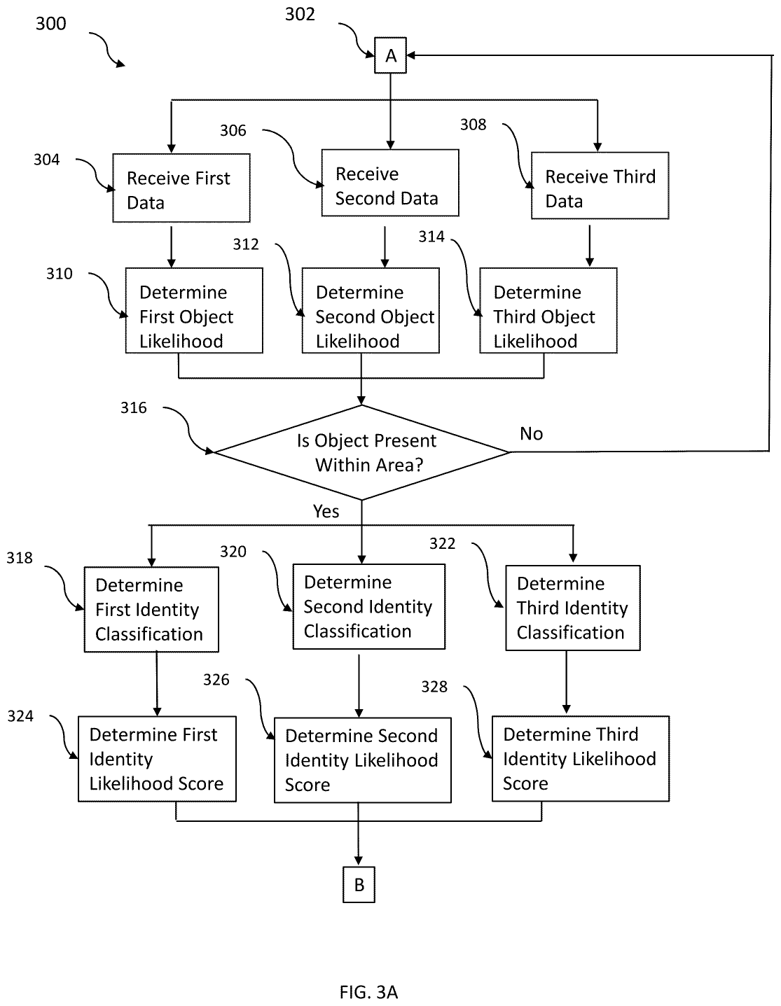

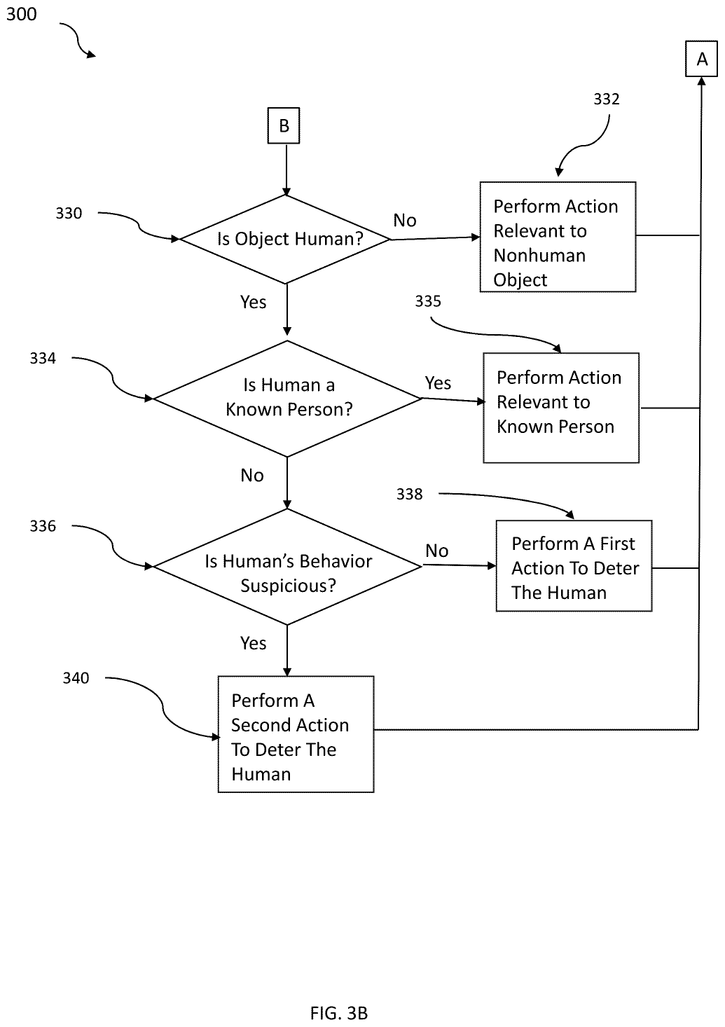

FIGS. 3A and 3B illustrate a flow diagram of a process 300 for providing security to an environment. The process 300 may be performed, in some embodiments, by a device or system, such as by the controller 106 of FIG. 1 and/or the security application 202 of FIG. 2 and the environment may include the environment 107 of FIG. 1. In these and other embodiments, the process 300 may be performed by one or more processors based on one or more computer-readable instructions stored on one or more non-transitory computer-readable media.

The process 300 may initiate by monitoring a plurality of sensors at a step 302 and include, at steps 304, 306, and 308 receiving first data from a first sensor, second data from a second sensor, and third data from a third sensor. This data may relate to a potential object that appears to exist within evaluation fields of the sensors. In some embodiments, the first data, the second data, and the third data may be received from different types of sensors. For example, the first data may be received from an image sensor, the second data may be received from a depth sensor, and the third data may be received from an audio sensor.

Once this data is received, in a step 310, a first object likelihood may be determined. In a step 312, a second object likelihood may be determined. In a step 314, a third object likelihood may be determined. The object likelihoods determined in steps 310, 312, and 314 may include a probability that the potential object within the evaluation fields is an actual object or that an actual object exists in one or more of the evaluation fields. Based on the likelihoods determined in steps 310, 312, and 314, a determination may be made in a step 316 as to whether the potential object corresponds to an actual object. If it is determined that the potential object does not correspond to an actual object, the process 300 may return back to the monitoring step 302.

If it is determined that the potential object does correspond to an actual object, a first identity classification may be determined in a step 318. A second identity classification may be determined in a step 320. A third identity classification may be determined in a step 322. These identity classifications may be determined separately for each sensor from which data is received. For example, the first identity classification may be determined based on data received from an image sensor. The second identity classification may be determined based on data received from a depth sensor. The third identity classification may be determined based on data received from an audio sensor.

The identity classifications determined in steps 318, 320 and 322 may identify a class to which the object belongs. For example, one or more of the identity classifications determined in steps 318, 320 and 322 may identify the object as a human, an animal, or a nonliving object. Subcategories for the object may also be determined in steps 318, 320, and 322. For example, an object may be classified not only as a human, but also as a female child. An object may be classified not only as an animal, but also as a dog or deer. An object may be classified not only as a nonliving object, but also as a box or a car.

In addition to determining identity classifications in steps 318, 320, and 322, in some embodiments, a first identity likelihood score may be determined in a step 324, a second identity likelihood score may be determined in a step 326, and a third identity likelihood score may be determined in a step 328. The likelihood scores determined in steps 324, 326, and 328 may provide a confidence level that the identity classifications determined in steps 318, 320, and 322 are accurate. The identity likelihood scores determined in steps 324, 326, and 328 may be presented in the form of numbers, such as a percentages, or another representation of confidence levels.

In a step 330, a determination may be made as to whether the object is human. If it is determined that the object is not a human, in a step 332, an action may be performed that is relevant to the nonhuman object. For example, if the object is a box or package or other parcel, an alert may be sent to an appropriate person alerting them to the presence of the parcel. In another embodiment, if the object is an animal, a sound may be played or a light may be turned on to scare the animal away from the structure. Once the action in step 332 is performed, the process 300 may return back to the monitoring step 302.

If it is determined that the object is a human, in a step 334, a determination may be made as to whether the human is a known person. If it is determined that the human is a known person, in a step 335, an action may be performed that is relevant to the known human. This action may include, for example, activating lighting, playing music, opening or closing a window covering, turning a fan on or off, locking or unlocking a door, lighting a fireplace, powering an electrical outlet, turning on or play a predefined channel or video or music on a television or other device, starting or stopping a kitchen appliance, starting or stopping a sprinkler system, opening or closing a garage door, adjusting a temperature or other function of a thermostat or furnace or air conditioning unit. Once the action in step 335 is performed, the method may return back to the monitoring step 302.

However, if the human is not a known person, in a step 336, a determination may be made as to whether the human's behavior is suspicious. This determination may be made based on ana analysis of the person's behavior and a comparison of the person's behavior to a predefined set of suspicious or threatening behaviors and/or patterns. If it is determined that the human's behavior is not suspicious, a first action may be performed in a step 338 and the process 300 may return back to the monitoring step 302.

However, if it is determined that the human's behavior is suspicious, in a step 340, a second action may be performed to deter the human. The second action in the step 340 may be more aggressive than the action in the step 338. The first and second actions may include a voice message. For example, the action in the step 338 may be a voice that states “Can I help you?” while the action in the step 340 may be a voice that states “Get off of my property!”

The actions performed in steps 338 and/or 340 may also include, for example, a light or smart appliance may be turned on. In another embodiment, a sound may be played to deter the person. For example, a siren or alarm sound may be played. In some embodiments, the voice message may be associated with the suspicious behavior or the person. For example, if the person is wearing a hat, the message may identify the person as wearing a hat such as “Hey you wearing the hat!” Alternatively, the message may be associated with the suspicious behavior. For example, if the person is looking into the windows of a car, the message may state “Get away from my car!”

In some embodiments, an action may not be performed unless a person remains within an evaluation field for an identified period of time. For example, the action may not be performed unless the unknown person is in the evaluation field for at least 10 seconds. This period of time, however, may be shortened or lengthened based on the behavior of the person. For example, if the person's behavior is suspicious, the period of time may be shortened. However, if the person's behavior is not suspicious, the length of time may be may extended, increased, paused, tolled, and/or otherwise adjusted, before performing a deter action. After the action is performed or it is determined that the person did not remain within the evaluation for the identified period of time, the process 300 may return back to the monitoring step 302.

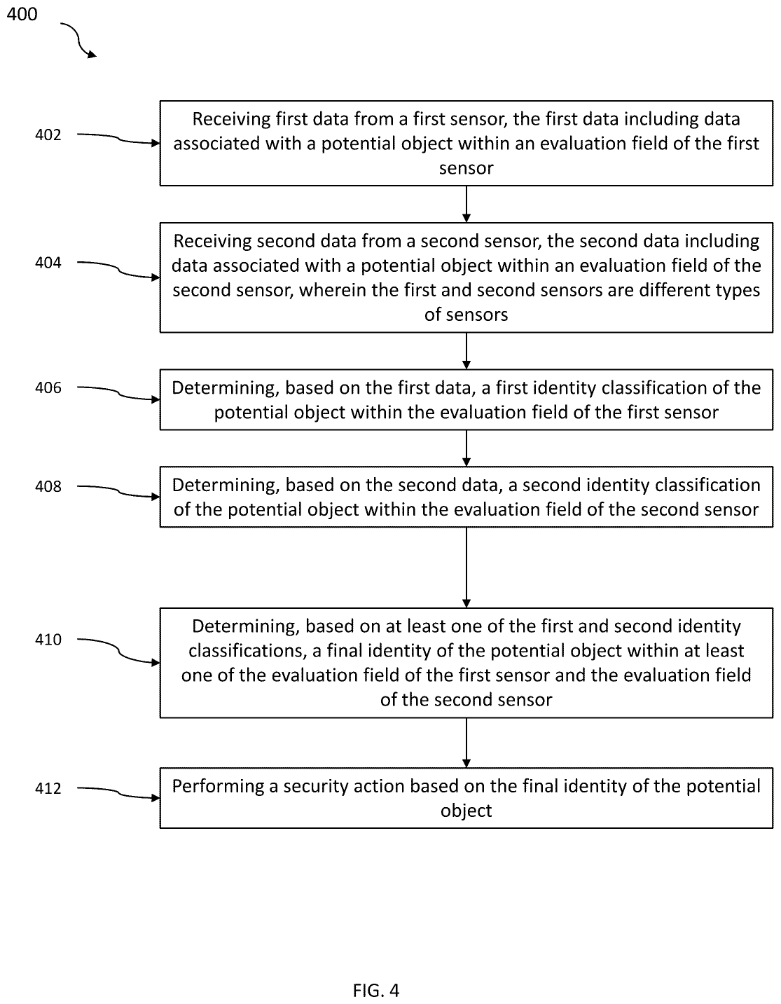

FIG. 4 illustrates a flowchart of an example method 400 for securing an environment. The method 400 may be performed, in some embodiments, by a device or system, such as by the controller 106 of FIG. 1 and/or the security application 202 of FIG. 2. In these and other embodiments, the method 400 may be performed by one or more processors based on one or more computer-readable instructions stored on one or more non-transitory computer-readable media.

The method 400 may include, at action 402, receiving first data from a first sensor, the first data including data associated with a potential object within an evaluation field of the first sensor and, at action 404, receiving second data from a second sensor, the second data including data associated with a potential object within an evaluation field of the second sensor. In this embodiment, the first and second sensors are different types of sensors. Different types of sensors include image sensors, depth sensors, and audio sensors. For example, in one embodiment the first sensor may be an image sensor and the second sensor may be a depth sensor or an audio sensor. In another embodiment the first sensor may be a depth sensor and the second sensor may be an image sensor or an audio sensor. In another embodiment the first sensor may be an audio sensor and the second sensor may be an image sensor or a depth sensor.

The method 400 may include, at action 406, determining, based on the first data, a first identity classification for the potential object within the evaluation field of the first sensor and, at action 408, determining, based on the second data, a second identity classification for the potential object within the evaluation field of the second sensor. The first and second identity classifications may classify the potential object as a human, an animal, a nonliving object, or it may be determined that there is no actual object, and the potential object is nothing. In addition to these broad classifications, more narrow subcategories may also be identified. For example, the potential object may be identified not just as a human, but as a child or a woman. The potential object may be identified not just as an animal, but as a dog or a deer. The potential object may be identified not just as a nonliving object, but as a box or a car.

In some embodiments, the first identity classifications may include a first identity likelihood score and the second identity classification may include a second identity likelihood score. The first and second identity likelihood scores may indicate levels of confidence that the first and second identity classifications are correct. These confidence levels may be represented by numbers, such as percentages, or by some other metric. The first and second identity likelihood scores may be based on how clear the data is from the sensors and on accuracy ratings for the sensors.

The method 400 may include, at action 410, determining, based on at least one of the first and second identity classifications, a final identity of the potential object within at least one of the evaluation field of the first sensor and the evaluation field of the second sensor. To determine a final identity, one of a number of different rules may be implemented. For example, in one embodiment, determining a final identity of an object may require that the first and second identity classifications identify the same object, such as human or animal.

In embodiments where the first and second identity classifications include first and second identity likelihood scores, the final identity may be based on one or both of the first and second identity likelihood scores exceeding a threshold level. Alternatively, where the first and second identity classifications identify different objects, the final identity may be the object identified with the highest identity likelihood score.

In embodiments where the potential object is determined to be a human, the method 400 may further comprise accessing a database containing data associated with features of known people and determining, based on a comparison between the data associated with features of known people and the first data received from a sensor, whether the human is a known person or an unknown person. In this embodiment, the data associated with features of known people include at least one of: facial features, retinal scans, posture, gait, height, or weight.

If the human is determined to be an unknown person, the method may further comprise accessing a database containing data associated with suspicious behavior patterns and determining, based on a comparison between the data associated with suspicious behavior patterns and data received from a sensor, that the unknown person is engaging in a suspicious behavior. This suspicious behavior may include at least one of: checking over a shoulder, running, walking past frequently, wearing a mask, carrying a crowbar or weapon, crawling on the ground, creeping, damaging or picking up a package, touching a car, opening a car door, peaking into a car, opening a mailbox, opening a building door, opening a window, breaking a window, or throwing something.

In another embodiment, the database may include data associated with safe behavior patterns. In this embodiment, the method may further comprise determining, based on a comparison between the data associated with suspicious behavior patterns and data received from a sensor, that the unknown person is engaging in a safe behavior. This safe behavior may include at least one of: walking a dog, riding a bike, delivering a package, or performing yard work.

The method 400 may include, at action 412, performing a security action based on the final identity of the potential object. The security action may include turning on or off a light or any number of different devices such as a television or a radio or an appliance within the home. The security action may also include playing any number of different voice messages. In embodiments where the potential object is determined to be an unknown person, the voice message may be directly associated with the unknown person. For example, the voice message may identify what the unknown person is wearing, holding, or doing.

In some embodiments, the security action may only be performed if an unknown person remains within at least one of the evaluation field of the first sensor and the evaluation field of the second sensor for more than an identified period of time. This period of time may be adjustable and may be decreased if the unknown person is engaging in a suspicious behavior. Alternatively, the period of time may be decreased if the unknown person is engaging in a safe behavior.

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to” unless expressly specified otherwise. An enumerated listing of items does not imply that any or all of the items are mutually exclusive and/or mutually inclusive, unless expressly specified otherwise. The terms “a,” “an,” and “the” also refer to “one or more” unless expressly specified otherwise.

Furthermore, the described features, advantages, and characteristics of the embodiments may be combined in any suitable manner. One skilled in the relevant art will recognize that the embodiments may be practiced without one or more of the specific features or advantages of a particular embodiment. In other instances, additional features and advantages may be recognized in certain embodiments that may not be present in all embodiments. These features and advantages of the embodiments will become more fully apparent from the following description and appended claims or may be learned by the practice of embodiments as set forth hereinafter.

As will be appreciated by one skilled in the art, aspects of the present invention may be embodied as a system, method, and/or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module,” or “system.” Furthermore, aspects of the present invention may take the form of a computer program product embodied in one or more computer readable medium(s) having program code embodied thereon.

Many of the functional units described in this specification have been labeled as modules to emphasize their implementation independence more particularly. For example, a module may be implemented as a hardware circuit comprising custom very large scale integrated (“VLSI”) circuits or gate arrays, off-the-shelf semiconductor circuits such as logic chips, transistors, or other discrete components. A module may also be implemented in programmable hardware devices such as an FPGA, programmable array logic, programmable logic devices or the like.

Modules may also be implemented in software for execution by various types of processors. An identified module of program code may, for instance, comprise one or more physical or logical blocks of computer instructions which may, for instance, be organized as an object, procedure, or function. Nevertheless, the executables of an identified module need not be physically located together but may comprise disparate instructions stored in different locations which, when joined logically together, comprise the module and achieve the stated purpose for the module.

Indeed, a module of program code may be a single instruction, or many instructions, and may even be distributed over several different code segments, among different programs, and across several memory devices. Similarly, operational data may be identified and illustrated herein within modules and may be embodied in any suitable form and organized within any suitable type of data structure. The operational data may be collected as a single data set or may be distributed over different locations including over different storage devices, and may exist, at least partially, merely as electronic signals on a system or network. Where a module or portions of a module are implemented in software, the program code may be stored and/or propagated on in one or more computer readable medium(s).

The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a server, cloud storage (which may include one or more services in the same or separate locations), a hard disk, a solid state drive (“SSD”), an SD card, a random access memory (“RAM”), a read-only memory (“ROM”), an erasable programmable read-only memory (“EPROM” or Flash memory), a static random access memory (“SRAM”), a Blu-ray disk, a memory stick, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network, a personal area network, a wireless mesh network, and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (“ISA”) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the C programming language or similar programming languages.

The computer readable program instructions may execute entirely on the user's computer, partly on the user's computer, as a stand-alone software package, partly on the user's computer and partly on a remote computer 125 or service or entirely on the remote computer 125 or server or set of servers. In the latter scenario, the remote computer 125 may be connected to the user's computer through any type of network, including the network types previously listed. Alternatively, the connection may be made to an external computer (for example, through the Internet using an Internet Service Provider). In some embodiments, electronic circuitry including, for example, programmable logic circuitry, FPGA, or programmable logic arrays (“PLA”) may execute the computer readable program instructions by utilizing state information of the computer readable program instructions to personalize the electronic circuitry to perform aspects of the present invention.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The schematic flowchart diagrams and/or schematic block diagrams in the Figures illustrate the architecture, functionality, and operation of possible implementations of apparatuses, systems, methods, and computer program products according to various embodiments of the present invention. In this regard, each block in the schematic flowchart diagrams and/or schematic block diagrams may represent a module, segment, or portion of code, which comprises one or more executable instructions of the program code for implementing the specified logical functions.

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and program code.

As used herein, a list with a conjunction of “and/or” includes any single item in the list or a combination of items in the list. For example, a list of A, B and/or C includes only A, only B, only C, a combination of A and B, a combination of B and C, a combination of A and C or a combination of A, B and C. As used herein, a list using the terminology “one or more of” includes any single item in the list or a combination of items in the list. For example, one or more of A, B and C includes only A, only B, only C, a combination of A and B, a combination of B and C, a combination of A and C or a combination of A, B and C. As used herein, a list using the terminology “one of” includes one and only one of any single item in the list. For example, “one of A, B and C” includes only A, only B or only C and excludes combinations of A, B and C. As used herein, “a member selected from the group consisting of A, B, and C,” includes one and only one of A, B, or C, and excludes combinations of A, B, and C.” As used herein, “a member selected from the group consisting of A, B, and C and combinations thereof” includes only A, only B, only C, a combination of A and B, a combination of B and C, a combination of A and C or a combination of A, B and C.

Means for performing the steps described herein, in various embodiments, may include one or more of a network interface, a processor (e.g., a CPU, a processor core, an FPGA or other programmable logic, an ASIC, a controller, a microcontroller, and/or another semiconductor integrated circuit device), an HDMI or other electronic display dongle, a hardware appliance or other hardware device, other logic hardware, and/or other executable code stored on a computer readable storage medium. Other embodiments may include similar or equivalent means for performing the steps described herein.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

1. A computer-implemented method for securing an environment, at least a portion of the method being performed by a computing device comprising one or more processors, the method comprising:
receiving first data from a first sensor, the first data including data associated with a potential object within an evaluation field of the first sensor;
receiving second data from a second sensor, the second data including data associated with a potential object within an evaluation field of the second sensor, wherein the first and second sensors are different types of sensors;
determining, based on the first data, a first identity classification of the potential object within the evaluation field of the first sensor;
determining, based on the second data, a second identity classification of the potential object within the evaluation field of the second sensor;
determining, based on at least one of the first and second identity classifications, a final identity of the potential object within at least one of the evaluation field of the first sensor and the evaluation field of the second sensor; and
performing a security action based on the final identity of the potential object.

2. The method of claim 1, wherein the first sensor is an image sensor and the second sensor is a depth sensor or an audio sensor.

3. (canceled)

4. The method of claim 1, wherein the first sensor is a depth sensor and the second sensor is an image sensor or an audio sensor.

5. (canceled)

6. (canceled)

7. The method of claim 1, wherein the first sensor is an audio sensor and the second sensor is an image sensor or a depth sensor.

8. (canceled)

9. The method of claim 1, wherein:
the first identity classification is a human, an animal, a nonliving object, or an absence of an object within the evaluation field of the first sensor, and
the second identity classification is a human, an animal, a nonliving object, or an absence of an object within the evaluation field of the second sensor.

10. The method of claim 9, wherein determining the final identity of the potential object is based on a matching potential object being identified by both the first and second identity classifications.

11. The method of claim 1, wherein:
the first identity classification includes a first identity likelihood score that provides a confidence level that the first identity classification is accurate, and
the second identity classification includes a second identity likelihood score that provides a confidence level that the second identity classification is accurate.

12. The method of claim 11, further comprising:
weighting the first identity likelihood score based on an accuracy rating of the first sensor; and
weighting the second identity likelihood score based on an accuracy rating of the second sensor.

13. The method of claim 11, wherein determining the final identity of the potential object is based on:
the first identity likelihood score exceeding a threshold level of confidence, or
the second identity likelihood score exceeding a threshold level of confidence, or
both the first and second identity likelihood scores exceeding a threshold level of confidence.

14. The method of claim 1, wherein:
the first identity classification of the potential object within the evaluation field of the first sensor is a human, and
the final identity of the potential object is determined to be a human.

15. The method of claim 14, further comprising:
accessing a database containing data associated with features of known people; and
determining, based on a comparison between the data associated with features of known people and the first data received from the first sensor, whether the human is a known person or an unknown person.

16. (canceled)

17. The method of claim 14, further comprising:
accessing a database containing data associated with features of known people; and
determining, based on a comparison between the data associated with features of known people and the first data received from the first sensor, that the human is a known person.

18. The method of claim 17, wherein the security action includes at least one of: activating lighting, playing music, opening or closing a window covering, turning a fan on or off, locking or unlocking a door, lighting a fireplace, powering an electrical outlet, turning on or play a predefined channel or video or music on a television or other device, starting or stopping a kitchen appliance, starting or stopping a sprinkler system, opening or closing a garage door, adjusting a temperature or other function of a thermostat or furnace or air conditioning unit.

19. The method of claim 14, further comprising:
accessing a database containing data associated with features of known people;
determining, based on a comparison between the data associated with features of known people and the first data received from the first sensor, that the human is an unknown person;
accessing a database containing data associated with suspicious behavior patterns; and
determining, based on a comparison between the data associated with suspicious behavior patterns and the first data received from the first sensor, that the unknown person is engaging in a suspicious behavior.

20. The method of claim 19, wherein the suspicious behavior includes at least one of: crawling, creeping, running, looking over a shoulder, picking up a package, touching a car, opening a car door, peaking into a car, opening a mailbox, opening a door, opening a window, holding a weapon, screaming, or throwing something.

21. (canceled)

22. (canceled)

23. (canceled)

24. (canceled)

25. The method of claim 19, wherein the security action is performed if the unknown person remains within at least one of the evaluation field of the first sensor or the evaluation field of the second sensor for more than an identified period of time.

26. The method of claim 25, wherein the identified period of time is adjustable based on the suspicious behavior.

27. The method of claim 14, further comprising:
accessing a database containing data associated with features of known people;
determining, based on a comparison between the data associated with features of known people and the first data received from the first sensor, that the human is an unknown person;
accessing a database containing data associated with safe behavior patterns; and
determining, based on a comparison between the data associated with suspicious behavior patterns and the first data received from the first sensor, that the unknown person is engaging in a safe behavior.

28. The method of claim 27, wherein the safe behavior includes at least one of: walking a dog, riding a bike, delivering a package, or performing yard work.

29. The method of claim 27, wherein the security action is performed if the unknown person remains within at least one of the evaluation field of the first sensor and the evaluation field of the second sensor for more than an identified period of time.

30. (canceled)
